(19) United States
(12) Patent Application Publication
(10) Pub. No.: US 2007/0300167 A1
(43) Pub. Date: Dec. 27, 2007

(54) Integrated development environment and related methods

(76) Inventors: Prashanth Kadur, Coram, NY (US); James Fagioli, Holtsville, NY (US)

Correspondence Address: FAY KAPLUN & MARCIN, LLP, 15O BROADWAY, SUITE 702, NEW YORK, NY, 10038, US

(21) Appl. No.: 11/471,948

(22) Filed: Jun. 21, 2006

(51) Int. Cl. G06F 9/00; G06F 3/00

(52) U.S. Cl. 715/762

(57) ABSTRACT

Described is an integrated development environment for building an application and related methods. The integrated development environment comprises a first form corresponding to a first set of data input devices, a second form corresponding to a second set of data input devices, and a data input control. When the data input control is inserted into the first form, the application is configured to receive input data generated by a first input device from the first set. When the data input control is inserted into the second form, the application is configured to receive the input data generated by a second input device from the second set.

### FIELD OF THE INVENTION

The present invention relates generally to integrated development environments and methods related thereto.

### BACKGROUND

A conventional Integrated Development Environment (IDE) is a programming environment including tools such as a graphical user interface (GUI) builder, a text/code editor, a compiler or interpreter and a debugger. Application developers use these tools, along with standard forms and controls provided by the IDE, to create software applications. The standard forms and controls correspond to standard functions that the application may execute, e.g., receiving input data from a keypad and/or a touch screen. However, the standard forms do not provide for advanced functions, e.g., receiving the input data from a bar code scanner. To make the standard controls aware of the advanced functions, the application developer would be required to write a significant amount of complex code, which requires a high level of skill and a significant amount of time. Therefore, there is a need for a programming environment which provides forms for advanced functions.

### SUMMARY OF THE INVENTION

The present invention relates to an integrated development environment and methods related thereto. The integrated development environment comprises a first form corresponding to a first set of data input devices, a second form corresponding to a second set of data input devices, and a data input control. When the data input control is inserted into the first form, the application is configured to receive input data generated by a first input device from the first set. When the data input control is inserted into the second form, the application is configured to receive the input data generated by a second input device from the second set.

### DESCRIPTION OF THE DRAWINGS

FIG. 1 shows an exemplary embodiment of an integrated development environment according to the present invention.

FIG. 2 shows an exemplary embodiment of a method according to the present invention.

FIG. 3 shows an exemplary embodiment of a mobile computing unit executing an application according to the present invention.

### DETAILED DESCRIPTION

The present invention may be further understood with reference to the following description and the appended drawings, wherein like elements are referred to with the same reference numerals. The present invention describes an integrated development environment (IDE) and methods related thereto. While the exemplary embodiments are described with reference to generating an application providing advanced data capture functionality for a mobile computing device, those of skill in the art will understand that the present invention may be used to design any type of software application providing advanced data capture/processing functionality for any type of computing device.

The exemplary embodiments of the present invention may be implemented as an IDE or as an extension to an existing IDE. In the latter case, the present invention may be provided as a plug-in, allowing a developer using the existing IDE to write applications which utilize advanced data capture methods. The plug-in may be one of a plurality of plug-ins provided in a software kit for use with the existing IDE.

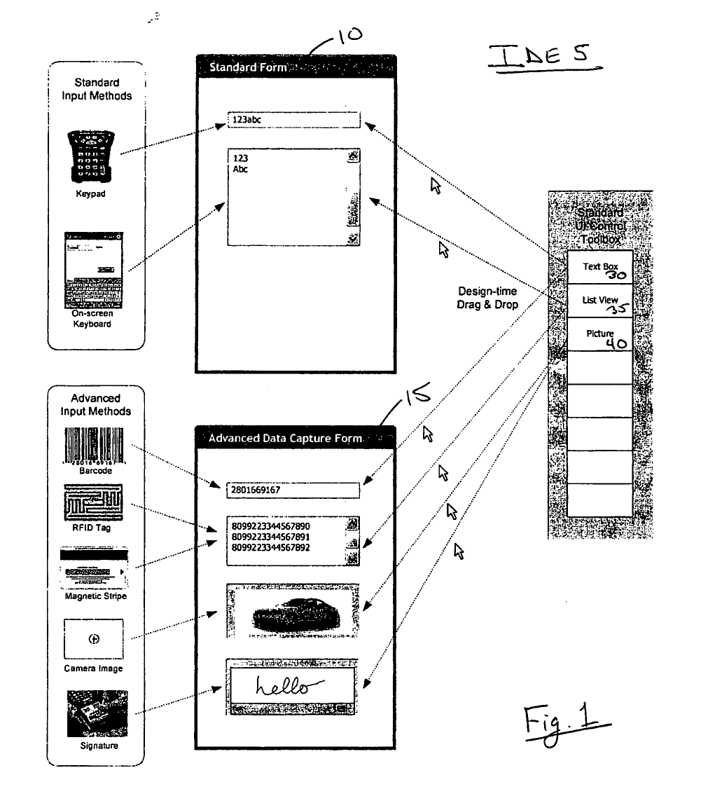

FIG. 1 shows an exemplary embodiment of an IDE 5 according to the present invention. The IDE 5 may provide a tool set similar to those provided by a conventional IDE including a graphical user interface (GUI) builder, a text/code editor, a compiler or interpreter and a debugger. In the exemplary embodiment, the IDE 5 may be used to build an application which includes a data capture module. For example, the application may be intended for use on a mobile computing unit (MU) that is integral with and/or communicatively coupled to a data capture device, e.g., a laser-based scanner, an imager-based scanner, an RFID reader, a magnetic stripe reader, a digital camera, a touch screen, a keypad, a keyboard, a signature capture pad, etc. The components of the IDE 5 allow the application developer to construct, compile and debug the application before being tested/implemented on the MU.

The IDE 5, as with conventional IDEs, provides a set of standard forms and standard controls. The standard forms may include (1) blank forms so that the developer can build the application from scratch, (2) templates for canned applications or application components and/or (3) completed applications for the developer to modify and/or customize. The standard controls are elements which, when inserted into one of the standard forms, provide a corresponding functionality for the application. For example, a standard data capture form 10 may correspond to a first set of device (e.g., a keypad, a keyboard, a touch screen, etc.) providing input data to the application. The developer selects the control based on which one of the devices supplies the input data to the application. When the developer inserts a text box control 30 into the standard form 10, the application is configured to receive input data from a keypad/keyboard. When a list view control 35 is inserted into the standard form 10, the application is configured to receive the input data from a touch screen (e.g., when it presents an on-screen keypad/keyboard).

The exemplary embodiments of the present invention provide additional forms for use with the standard controls, allowing the developer to add functionality to the application without writing large amounts of code. As shown in FIG. 1, the IDE 5 provides, for example, an advanced data capture (ADC) form 15 which correspond to a second set of device that generate the input data. When the text box control 30 is inserted into the ADC form 15, the application may be configured to receive the input data from a bar code scanner (e.g., a laser-based scanner or imager-based scanner). When the list view control 35 is inserted into the ADC form 15, the application may be configured to receive the input data from an RFID reader (as RFID tag identifiers) and/or a magnetic stripe reader (as credit card numbers, customer account numbers, etc.).

A picture control 40 may also be provided by the IDE 5 as one of the standard controls or specifically for use with the ADC form 15. In one exemplary embodiment, when the picture control 40 is inserted into the ADC form 15, the application is configured to receive the input data from an image capture device (e.g., an imager-based scanner, a digital camera, etc.). In another exemplary embodiment, the picture control 40 configures the application to receive the input data from a touch screen (e.g., when it is used for signature capture, thumbprint (or other biometric) reading, etc.).

Those of skill in the art will understand that the controls represent segments of code which, when executed, allow the application to perform a predetermined function (e.g., receive the input data from a data capture device). The IDE 5 modifies the code based on the form into which the control is inserted. The modified code provides the function desired by the developer. For example, the text box control 30 represents a portion of code. When the text box control 30 is inserted into the standard form, the IDE 5 modifies the code, allowing the application to receive the input data from a keypad. However, the IDE 5 performs a different modification on the code when the text box control 30 is inserted into the ADC form 15 which allows the application to receive the input data from a bar code scanner. Thus, the IDE 5 may automatically generate the code for the application as the developer manipulates the forms and controls. Those of skill in the art will understand that the IDE 5 may provide various forms for use with the standard controls. Additional forms, besides the ADC form 15, may relate to data processing, display modalities, etc.

In an alternative exemplary embodiment, the IDE 5 may provide images (and/or descriptions) of devices which produce the input data rather than the standard controls. For example, the developer may indicate that the application should receive the input data from a bar code scanner by selecting an image of the bar code scanner. The IDE 5 may then select the ADC form 15 with the text box control 30 inserted therein. In this embodiment, the developer could be completely inexperienced with the IDE 5 and build the data capture module of the application by simply selecting the device that provides the input data.

In another exemplary aspect of the present invention, the input data may be routed to corresponding fields based on a source/type of the input data. Conventionally, when a user is typing on a keypad of an MU, text is entered at a location of a cursor. For example, when the user is filling in a form presented electronically on a display of the MU, the text is entered into a field in which the cursor is located. The user enters text in further fields by manipulating the location of the cursor and then typing. However, when the user puts down the MU, performs another task between entering the text, navigates between forms/screens on the MU, etc., the location of the cursor may be unknown or forgotten. This leads to the user entering text into an incorrect field, erasing the text and repositioning the cursor into a correct field. Entering text into the incorrect field (and otherwise not being aware of the cursor location) may become increasingly frustrating to the user.

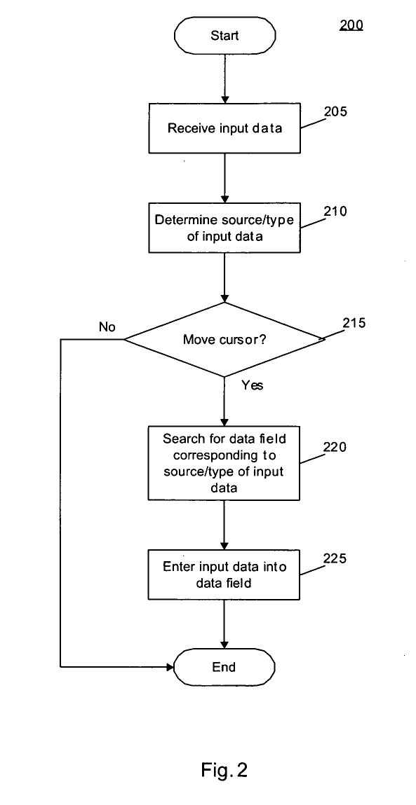

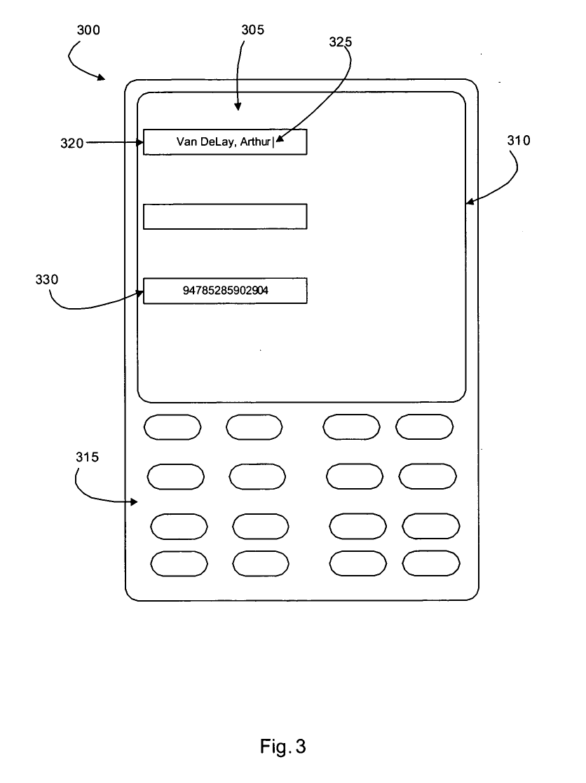

FIG. 2 shows an exemplary embodiment of a method 200 for routing the input data to corresponding data fields according to the present invention. The method 200 will be described with reference to an exemplary embodiment of an MU 300 which is shown in FIG. 3. The MU 300 is running an application which shows an image of a form 305 on a display 310. The form 305 includes a plurality of data fields which are to be filled in either manually (e.g., text from keypad 315) or automatically (e.g., scanning a bar code). In the exemplary embodiment of the method 200, the user has entered text into a data field 320 and a cursor 325 remains at the end of the text. Also in the exemplary embodiment, the MU 300 includes a bar code scanner for scanning bar codes. However, those of skill in the art will understand that the MU may utilize any data capture device, examples of which are provided above.

In step 205, the application receives the input data. In step 210, the application determines a source/type of the input data. For example, the input data may have been generated by the keypad 315, the bar code scanner, etc. The source/type of the input data may be determined by its format, which input channel it is received on, or any other parameter/characteristic which would be indicative of its source. The application may perform a predetermined signal processing procedure on the input data to determine the source/type.

In step 215, it is determined whether the cursor 325 should be moved to another data field based on the source/type of the input data. For example, if the input data was generated by the keypad 315, the application may assume that the user is still typing in the data field 320 and leave the location of the cursor 325 unchanged. However, if the input data was generated by the bar code scanner, the method 200 proceeds to step 220, in which the application searches the form 305 for a next field which receives data corresponding to the source/type of the input data. The application may perform, for example, a top-down search of each data field in the form 305 beginning with the data field in which the cursor 325 is currently located (e.g., the data field 320). In the exemplary embodiment, the search yields a data field 330, because it receives bar code data. Data field 335 may have been bypassed by the application, because it receives input data from the keypad 315. Those of skill in the art will understand that any search algorithm may be utilized to find the data field 330 such as, for example, searching the entire form 305 beginning at a topmost data field, searching data fields closest to the cursor location first, etc.

In step 225, the input data is entered in the data field 330. The input data may be entered automatically, or the application may provide a user confirmation mechanism to ensure that the input data is entered in the correct data field. For example, if the user scanned a bar code but intended to enter the input data in a last data field in the form 305, the application provides the means to deposit the input data in data fields other than the data field 330 (i.e., the next data field which is meant to receive the type of input data). In one exemplary embodiment, after the input data is entered into the data field 330, the application highlights the input data so that the user can move the input data to subsequent data fields which receive input data of that type. Thus, the user can jump the input data to other data fields (either up or down the form 305) by, for example, pressing arrow keys. The moves the input data to subsequent data fields which receive the same data (based on the source/type), until the user selects a particular data field.

In another exemplary embodiment, prior to entering the input data in the data field 330, the application relocates the cursor 325 to the data field 330. If that is the correct data field (as determined by the user), the user may press a button, touch the screen, etc. to enter the input data into the data field 330. If the data field 330 is incorrect, the user may move the cursor 325 to the correct data field and press the button, etc. to enter the input data therein.

Those of skill in the art will understand that the exemplary embodiments of the present invention provide several advantages in terms of user-friendliness and operational efficiency. In the first exemplary embodiment, the ADC form 15 allows the developer to build an application with advanced data capture capabilities without having to code the controls. In the second exemplary embodiment, the input data is routed to its correct field in the form 305 which eliminates overwriting and incorrect entries.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. An integrated development environment (IDE) for building an application, comprising:
a first form corresponding to a first set of data input devices;
a second form corresponding to a second set of data input devices; and
a data input control,
wherein, when the data input control is inserted into the first form, the application is configured to receive input data generated by a first input device from the first set, and
wherein, when the data input control is inserted into the second form, the application is configured to receive the input data generated by a second input device from the second set.

2. The IDE of claim 1, wherein the first set includes at least one of a keypad, a keyboard and a touch screen.

3. The IDE of claim 1, wherein the second set includes at least one of a laser-based scanner, an imager-based scanner, an RFID reader, a magnetic stripe reader, a digital camera, a signature capture device and a biometric reader.

4. The IDE of claim 1, wherein the data input control is one of a text box control, a list view control and a picture control.

5. The IDE of claim 4, wherein, when one of the text box control and the list view control is inserted into the first form, the application is configured to receive the input data from at least one of a keypad, a keyboard and a touch screen.

6. The IDE of claim 4, wherein, when one of the text box control and the list view control is inserted into the second form, the application is configured to receive the input data from one of a laser-based scanner, an imager-based scanner, an RFID reader and a magnetic stripe reader.

7. The IDE of claim 4, wherein, when the picture control is inserted into the second form, the application is configured to receive the input data from one of a digital camera, a signature capture device and a biometric reader.

8. The IDE of claim 1, further comprising:
a code generator generating software code for the application when the data input control is inserted into one of the first and second forms.

9. An integrated development environment (IDE) for building an application, comprising:
a form;
a plurality of images of data capture devices; and
wherein, when a selected image is inserted into the form, the application is configured to receive input data generated by a corresponding data capture device.

10. The IDE of claim 9, wherein the images include images of at least one of a standard data capture device and an advanced data capture device.

11. The IDE of claim 10, wherein the standard data capture device is at least one of a keypad, a keyboard and a touch screen.

12. The IDE of claim 10, wherein the advanced data capture device is at least one of a laser-based scanner, an imager-based scanner, an RFID reader, a magnetic stripe reader, a digital camera, a signature capture device and a biometric reader.

13. The IDE of claim 9, further comprising:
a code generator generating software code for the application when the data input control is inserted into one of the first and second forms.

14. An extension for an integrated development environment (IDE) for building an application, comprising:
an advanced data capture form,
wherein, when a standard data input control of the IDE is inserted into the advanced data capture form, the application is configured to receive input data generated by an advanced data capture device.

15. The extension of claim 14, wherein the advanced data capture device includes at least one of a laser-based scanner, an imager-based scanner, an RFID reader, a magnetic stripe reader, a digital camera, a signature capture device and a biometric reader.

16. The extension of claim 14, wherein the extension is a plug-in.

17. A method, comprising:
identifying a first location of a cursor in a data field of a form displayed on a display of a mobile computing device, the data field receiving data having a first data type;
receiving input data from a data input device communicatively coupled to the mobile computing device, the input data having a second data type; and
entering the input data into the data field as a function of a comparison of the first and second data types.
as a function of a comparison of the second data type and the first data type; and

18. The method of claim 17, wherein the entering step includes the following substeps:
when the second data type does not match the first data type, selecting a further data field in the form that is configured to receive data having the second data type; and
entering the input data into the further data field.

19. The method of claim 17, further comprising:
prior to the entering, displaying a confirmation prompt to confirm entry of the input data into the data field; and
selecting a further data field in the form as a function of a response to the confirmation prompt, the further data field configured to receive data having the first data type.

20. The method of claim 19, wherein the selecting step includes the following substep:
moving the cursor to the further data field;
displaying a further confirmation prompt to confirm entry of the input data into the further data field; and
entering the input data into the further data field as a function of a further response to the further confirmation prompt.
